(19) United States
(12) Patent Application Publication
(10) Pub. No.: US 2004/0041442 A1
(43) Pub. Date: Mar. 4, 2004

(54) Integrated wire harness attachments in sunroof guide channel frame

(76) Inventors: Daniel Cooney, Livonia, MI (US); Troy Allan, Howell, MI (US); John E. Long, Highland, MI (US); Karim Dayoub, Royal Oak, MI (US); Hyong Chol Park, Ann Arbor, MI (US); Bryan Tice, White Lake, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/228,561

(22) Filed: Aug. 27, 2002

(51) Int. Cl. B60J 7/057

(52) U.S. Cl. 296/216.08

(57) ABSTRACT

A movable panel assembly includes a guide channel having a mounting flange portion and a tab portion extending downward from the mounting flange portion. The tab portion includes a barbed configuration that cooperates with clips assembled to a corresponding wire harness. The clips integrally assembled to the wiring harness attach and securely fasten the wiring harness to the guide channel.

### BACKGROUND OF THE INVENTION

This invention generally relates to a sunroof for a motor vehicle and specifically to a sunroof including a guide channel frame having integrally formed wire harness mounting features.

Typically, a sunroof or moonroof in a motor vehicle includes a movable panel slidable within channels between open and closed positions. Some movable panels include a fully opened position along with a vented position. In the vented position, the glass panel is pivoted upward to provide a small opening on one side of the panel. Movement of the panel is facilitated by a guide channel mounted to the motor vehicle. The guide channel typically includes a channel portion cooperating with a tab portion of the movable panel. The guide channel also includes a gutter portion that facilitates evacuation of water from the movable panel area so that water does not intrude into the passenger compartment of the motor vehicle.

Typically, an electric motor drives the movable panel between open and closed positions. A wiring harness communicates electrical energy along with control signals to the motor in order to move the movable panel to the desired position. Multiple pieces of tape or clips secure the wire harness to the sunroof guide channel or frame. As appreciated, use of multiple pieces of tape or multiple separate clips complicates and increases the difficulty of assembling the movable panel to a motor vehicle.

Accordingly, it is desirable to design features within the guide channel to aid in assembly and mounting of a wire harness.

### SUMMARY OF THE INVENTION

An embodiment of this invention is a movable panel assembly including a guide channel having mounting features corresponding with mounting features integrally assembled to a wire harness.

The movable panel assembly of this invention includes a guide channel having a plurality of tabs extending from a mounting flange that cooperates with clips mounted on the wire harness. The clips correspond with the mounting tabs extending from the mounting flange of the movable panel guide channel.

Accordingly, embodiments of this invention improve the manufacturability of the sunroof assembly and increase the accuracy and dependability in which the wire harness is secured to the motor vehicle.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic view of the movable panel assembly incorporating the guide channels of this invention;

FIG. 2 is a cross-sectional view of the movable panel assembly;

FIG. 3 is a perspective view of one channel of the guide channel of this assembly;

FIG. 4 is a perspective view of an another embodiment of the guide channel;

FIG. 5 is a top view of the guide channel assembly;

FIG. 6 is a cross-sectional view of the guide channel shown in FIG. 4.

### DETAILED DESCRIPTION OF THE PREFERRED EMBODIMENT

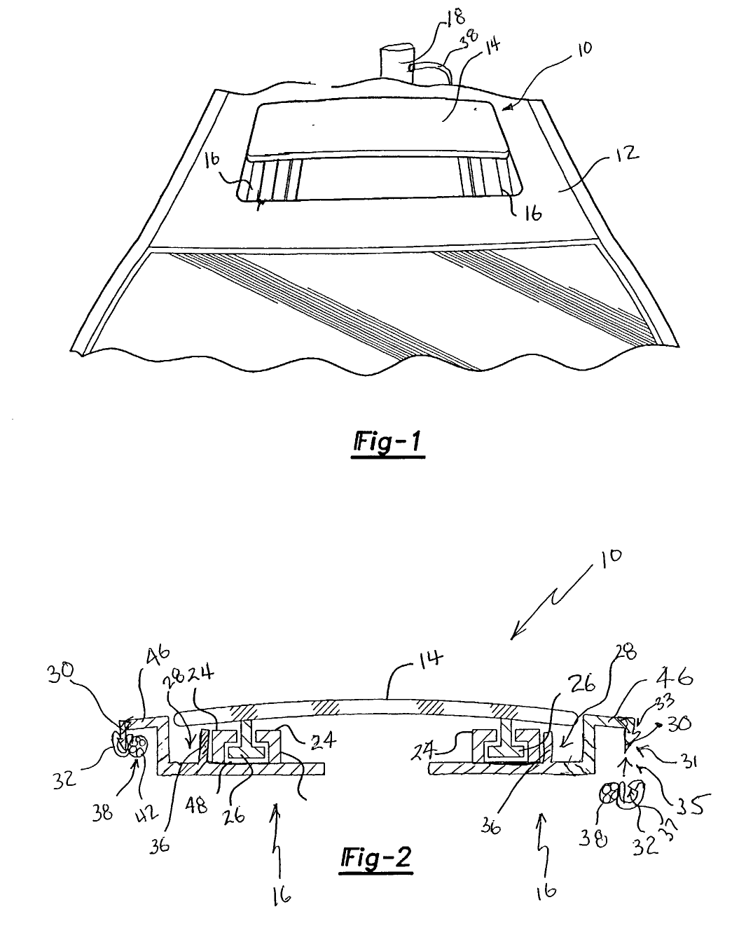

FIG. 1 schematically shows a sunroof assembly 10 installed in a motor vehicle 12. The sunroof assembly 10 includes a movable panel 14 slidable between open and closed positions within channels 16. Referring to FIG. 2, a cross-sectional view is shown of the movable panel assembly 10. The movable panel assembly 10 includes the movable panel 14 having guide portions 26 disposed within a guide channel 48. The guide portions 26 extend downward from the movable panel 14 into each of the guide channel 48. The guide channel 48 includes overlapping fingers 24 that trap the guide portion 26 of the movable panel 14.

The movable panel 14 slides between open and closed positions within the guide channels 48. Each of the channels 16 include the guide channel portion 48, a gutter portion 28 and attachment flange 46 along with a tab 30. The gutter portion 28 is formed by a wall 36. The wall 36 cooperates with the flange portion 46 to form a gutter for water evacuation. The flange portion 46 provides an attachment point for each of the channels 16.

The channels 16 includes the mounting flange portion 46 and a tab extending downward from the mounting flange 46. The tab portion 30 cooperates with clips 32 that are integrally formed and attached to the wiring harness 38. The wiring harness 38 includes multiple strands of wire 42 that communicate electrical energy and control signals to the electric motor 18.

The mounting tab 30 includes a flat portion 33 and a ramped portion 31 that form a barbed configuration that cooperates with a clip 32 attached to the wiring harness 38. The clip 32 is moved in the direction of the arrow 35 to engage the tab 30 and secure the wiring harness 38 to the channel 16. As appreciated, securing the wire harness 30 to the channel 16 in this manner eliminates the need for external and loose attachment devices as has been used in conventional wire harness assembly. Further, the tab portion 30 is an integral portion of the channel 16 eliminating a substantial amount of assembly and manufacturing steps.

Referring to FIG. 3, a perspective view showing the cross-section of a single channel 16 with a wiring harness 38. In this view, the channel 48, gutter portion 28, and flange portion 46 are as an end view along with the multiple tab portions disbursed along the length of the channel 16. Note that in this embodiment each of the tab portions 30 are intermittently arranged along the length of the channel 16. The tab portions 30 are disposed in this manner and cooperate with the specific locations of clips 32 that are assembled to the wiring harness 38.

The movable panel 14 slides within the channel 48 between the open and closed positions. Assembly of the wiring harness 38 is facilitated by engaging the plurality of clip already assembled to the wiring harness 38 to corresponding tab portions 30. Each of the clips 32 include a hook portion 37 (best shown in FIG. 2) that engages the barbed tab 30. As appreciated, although a barbed tab 30 is shown in this embodiment, it is within the contemplation of this invention that any tab configuration or shape is as is known to a worker skilled in the art for securing a wiring harness to a support structure would be within the contemplation of this invention.

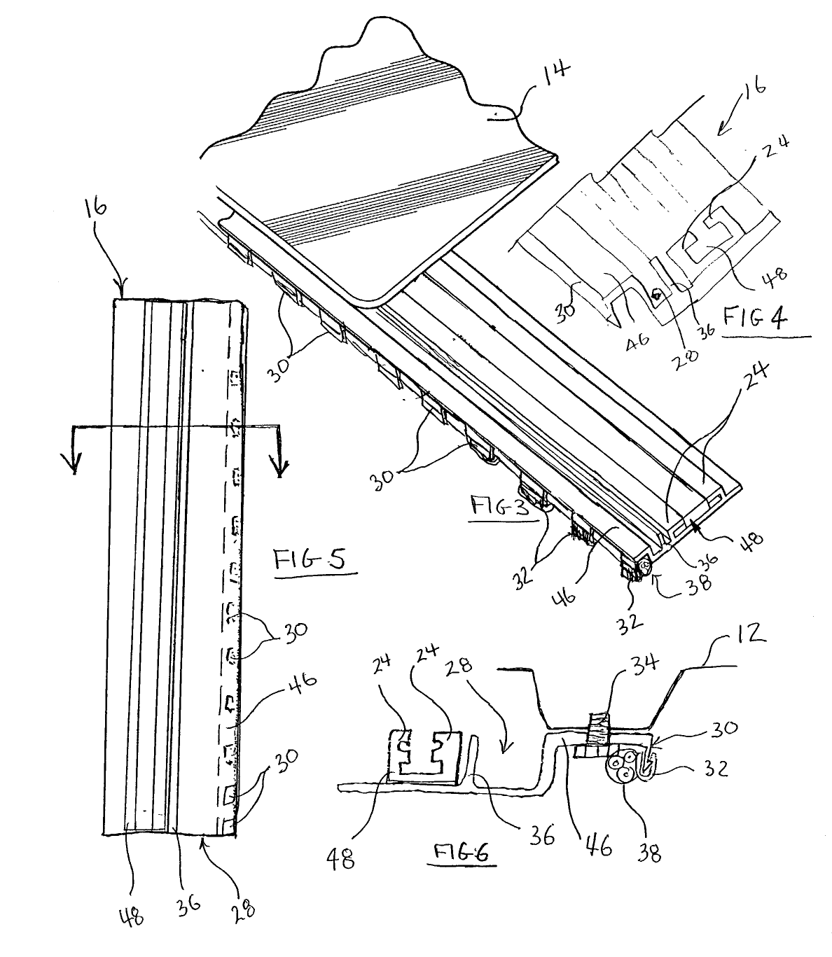

Referring to FIG. 4, the channel 16 includes a continuous tab portion 30 or rail extending along the entire length of the channel 16. Such a configuration would facilitate and eliminate the need to correspond positions of the wiring harness with the discreetly located tab portions 30.

Referring to FIG. 5, the channel 16 is shown in a plan view and includes the guide portion 48, the wall portion 36 that aids in forming the gutter portion 28 along with the flange 46. The tab portions 30 extend downward from the flange portion 46 in discreet locations along the length of the channel portions 16.

Referring to FIG. 6, the channel 16 includes the guide channel portion 48 having over extending fingers 24 for mounting of the tab portion of the movable 14 and sliding of the movable panel 14 between an open and closed position. The channel 16 also includes the wall member 36 that extends upward from the channel 16 to form a gutter portion 28. The gutter portion 28 aids in the evacuation of water and moisture away from the sunroof or movable panel assembly 14. Next to the gutter portion 28 and extending horizontally is an attachment flange portion 46. The attachment flange portion 46 includes an opening through which a threaded fastener 34 extends for securing and mounting of the channel 16 to a body portion 12 of the motor vehicle. The threaded fastener 34 is preferably of the self-tapping configuration as is known by a worker skilled in the art. However, it should be understood that it is within the contemplation that the threaded member 34 may be replaced with any type of fastening member known to a worker skilled in the art.

Extending downward from the mounting flange 46 is the tab portion 30. The tab portion 30 includes the barbed portion or configuration that is formed by the ramped portion 31 and flat portion 33. The tab 30 may be of any configuration known to a worker skilled in the art and the barbed configuration shown in this embodiment is just one of the many configurations that may be utilized in this invention. Many different tab formations as are known to a worker skilled in the art fall within the contemplation of this invention.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

What is claimed is:

1. A movable panel assembly for a vehicle comprising;
a panel movable between open and closed positions;
a wire harness assembly;
a channel for guiding said panel between said open and closed positions, said channel including a tab section corresponding to clips disposed on said wire harness assembly for mounting said wire harness to said guide channel.

2. The assembly of claim 1, wherein said guide channel includes a flange, and said tab section is disposed on a distal end of said flange.

3. The assembly of claim 2, wherein said clips are secured to said wire harness such that said clips are an integral part of said wire harness.

4. The assembly of claim 1, wherein a plurality of said tab section extends downward from said flange at common intervals.

5. The assembly of claim 1, wherein said tab section is a continuous section extending along said channel.

6. The assembly of claim 1, wherein said flange includes an opening through which a fastener extends for securing said guide channel to said vehicle.

7. The assembly of claim 1, wherein said tab section is hook shaped.

8. The assembly of claim 1, wherein said tab section extends transversely from said flange.

9. The assembly of claim 11, wherein said tab section includes a ramped portion terminating at a flat portion disposed transverse to said ramped portion.

10. The assembly of claim 1 wherein said guide channel is formed of extruding aluminum.

11. The assembly of claim 1, wherein said guide channel is formed by an injection molding process.
